(19) United States
(12) Patent Application Publication
(10) Pub. No.: US 2010/0113983 A1
(43) Pub. Date: May 6, 2010

(54) UTILIZING ULTRASOUND TO DISRUPT PATHOGENS

(75) Inventors: David E. Heckerman, Bellevue, WA (US); Simon John Mercer, Issaquah, WA (US); Chris Demetrios Karkanias, Sammamish, WA (US); Eric J. Horvitz, Kirkland, WA (US)

Correspondence Address: LEE & HAYES, PLLC, 601 W. RIVERSIDE AVENUE, SUITE 1400, SPOKANE, WA, 99201, US

(73) Assignee: MICROSOFT CORPORATION, Redmond, WA (US)

(21) Appl. No.: 12/262,881

(22) Filed: Oct. 31, 2008

(51) Int. Cl. A61H 1/00

(52) U.S. Cl. 601/2

(57) ABSTRACT

Provided are systems and/or methods that treat illnesses and conditions using ultrasound tuned to a resonant frequency of a target material with the assistance of computer processing. The ultrasound tuned to the resonance frequency of a target material destroys the target material without harming healthy material that surrounds the target material. A resonance frequency database can be employed to ensure that local healthy material surrounding a target has a natural resonance frequency dissimilar enough from the tuned resonance frequency.

### BACKGROUND

Ultrasound is cyclic sound pressure with a frequency greater than 20 kHz, which is the typical upper limit of human hearing. Ultrasound devices are commonly used to penetrate a medium and measure the reflection signature. The reflection signature provides details about an inner structure of the medium. For example, ultrasound devices are used in sonography to produce pictures of fetuses in the human womb.

Ultrasound is also used in high intensity focused ultrasound (HIFU), which is a non-invasive, targeted treatment option for treating renal stones, tumors, cancer, and related illnesses. HIFU involves focusing a high intensity ultrasound beam on the exact areas which need treatment. The focused beam creates an intense heat of 80-100° C. that can kill cancer cells.

HIFU relies on the same principles as conventional ultrasound. That is, both techniques involve propagating harmlessly through living tissue; however, when the ultrasound beam carries sufficient energy and is tightly focused, the energy within the focal volume can cause a local rise in temperature of sufficient magnitude to cause tissue death and necrosis. In other words, HIFU causes tissue damage by the conversion of mechanical energy into heat. The rate of energy deposition in the targeted tissues produces heat in a local region faster than the heat is dissipated by the surrounding tissue. Ideally, targeted tissue destruction occurs without damaging surrounding or overlying tissues.

Generally speaking, arrest of cellular reproduction occurs if the temperature is maintained above 43° C. for 60 min or longer. HIFU exploits the phenomenon that above 56° C. for 1 second rapid thermal toxicity occurs, causing irreversible cell death through coagulative necrosis. During HIFU treatments, the temperature at the focus rises rapidly above 80° C., which effectively destroys cells. Moreover, an advantage associated with HIFU is that there is a steep temperature gradient between the tissue within focus and the surrounding tissue.

### SUMMARY

The following presents a simplified summary of the innovation in order to provide a basic understanding of some aspects described herein. This summary is not an extensive overview of the claimed subject matter. It is intended to neither identify key or critical elements of the claimed subject matter nor delineate the scope of the subject innovation. Its sole purpose is to present some concepts of the claimed subject matter in a simplified form as a prelude to the more detailed description that is presented later.

In order to effectively treat illnesses and conditions without the use of drugs and thus without the possible detrimental side effects of drugs, a targeted treatment regime using ultrasound assisted with the benefits of computer processing is provided. Given that all objects have a specific resonance frequency (and portions of individual objects can have specific resonance frequencies), the subject innovation employs ultrasound tuned to the specific resonance frequency of a target in order to change, disrupt or destroy the target without harming healthy material that surrounds the target. A resonance frequency database can be created to ensure the local healthy material surrounding a target has a natural resonance frequency dissimilar enough from the tuned resonance frequency that affects some portion of the target.

The following description and the annexed drawings set forth in detail certain illustrative aspects of the claimed subject matter. These aspects are indicative, however, of but a few of the various ways in which the principles of the innovation may be employed and the claimed subject matter is intended to include all such aspects and their equivalents. Other advantages and novel features of the claimed subject matter will become apparent from the following detailed description of the innovation when considered in conjunction with the drawings.

### BRIEF DESCRIPTION OF THE DRAWINGS

FIG. 1 illustrates a block diagram of an exemplary system that facilitates using ultrasound tuned to the specific resonance frequency of a target in order to change, disrupt or destroy the target without harming healthy material that surrounds the target.

FIG. 2 illustrates another block diagram of an exemplary system that facilitates using ultrasound tuned to the specific resonance frequency of a target in order to change, disrupt or destroy the target without harming healthy material that surrounds the target.

FIG. 3 illustrates a method of using ultrasound tuned to the specific resonance frequency of a target in order to change, disrupt or destroy the target without harming healthy material that surrounds the target

FIG. 4 illustrates yet another block diagram of an exemplary system that facilitates using ultrasound tuned to the specific resonance frequency of a target in order to change, disrupt or destroy the target without harming healthy material that surrounds the target.

FIG. 5 is an exemplary computing environment in accordance with various aspects described herein.

FIG. 6 is an exemplary networked computing environment in accordance with various aspects described herein.

### DETAILED DESCRIPTION

The claimed subject matter is described with reference to the drawings, wherein like reference numerals are used to refer to like elements throughout. In the following description, for purposes of explanation, numerous specific details are set forth in order to provide a thorough understanding of the subject innovation. It may be evident, however, that the claimed subject matter may be practiced without these specific details. In other instances, well-known structures and devices are shown in block diagram form in order to facilitate describing the subject innovation.

Healthy cells and tissue have a natural frequency within which they resonate. Maladies such as viruses, bacteria, parasites, other infectious agents, and cancerous cells/tissue generally have different natural resonating frequency ranges compared to healthy cells and tissue. If a carefully selected level of ultrasound energy with a carefully selected frequency is delivered to a subject with a malady, the ultrasound energy has the capability of destroying viruses, bacteria, parasites, other infectious agents, and cancerous cells/tissue at their respective resonating frequencies. An advantage is that due to the differences in the natural resonance ranges, one frequency that disrupts or destroys viruses, bacteria, parasites, other infectious agents, and cancerous cells/tissue can leave healthy cells and tissue unharmed.

Resonance is the tendency of a system to oscillate at maximum amplitude at certain frequencies. The frequencies are typically referred to as the resonance frequencies or resonant frequencies of a system. At the resonant frequencies, even small periodic driving forces can produce large amplitude vibrations, because the system stores vibrational energy. The resonant frequency of a system is the natural free oscillation frequency of the system. A resonant system can be excited by a driving force such as ultrasound in a narrow band of frequencies unique to the system, equal or about equal to the resonant frequency thereby inducing resonance in a targeted structure. Thus, resonant frequency includes frequencies at or about the natural resonant frequency of the system including harmonic and subharmonic frequencies of the natural resonant frequency to induce resonance therein. Resonant energy is that energy sufficient to induce resonance in a structure.

Ultrasound is cyclic sound pressure with a frequency greater than the upper limit of human hearing, which is generally accepted as about 20 kilohertz (20,000 hertz). Ultrasound energy is energy that is produced when a physical structure vibrates and the vibrational energy of motion may be transferred to the surrounding medium which includes air, liquid, or solid typically through a coupling medium.

The applied ultrasound can have a frequency at, about, or close to the target material resonant frequency. While the applied ultrasound need not have the exact frequency of the target material resonant frequency, the range at which the applied ultrasound frequency differs from target material resonant frequency depends on at least two factors. The first factor is the effectiveness of the applied ultrasound frequency, that is not exactly equal to the target material resonant frequency, to destroy or render harmless a target material. The second factor is the resonant frequency of healthy cells and tissues surrounding the target material, since the applied ultrasound frequency minimally detrimentally effects the healthy cells and tissues surrounding the target material. The narrow band of frequencies includes at least one resonant frequency of a target material, but does not include the resonant frequency of surrounding healthy tissues or induce damage to surrounding healthy tissues.

While not wishing to be bound by any theory, it is believed that application of ultrasound tuned to the specific resonance frequency of a target material causes a rapid increase in internal energy within the target material. The energy kept in the target material can cause disruption or destruction of the target material, via cavitation and/or compression/rarefaction. In other words, ultrasound tuned to the specific resonance frequency of a target material destroys the target material by cavitation and/or compression/rarefaction. Cavitation is the formation of vapor-filled cavities in substances, for example, bubble formation in water upon boiling, which leads to the destruction of a target. Vibration at resonance frequency induces alternating compression and rarefaction which constitute mechanical stress severe enough to destroy a target material.

The systems and methods described herein inducing acoustic resonance in a target material with select or a narrow band of frequencies that affect the specific target material but have virtually no effect on nearby structures. The systems and methods selectively affect a target material by using resonant frequencies which can transfer destructive energy to target materials while leaving surrounding or nearby structures, which are not in resonance at the resonant frequencies employed, virtually unchanged. Nearby or surrounding structures include healthy tissues and cells, that can be within a living body or in a sample withdrawn from a living body.

Destruction of a target material includes the structural failure of the target material resulting in lysis, shattering, rupture, or inactivation of the target material or of one or more components of the target material. Destruction also includes inhibition of vital processes required for growth, reproduction, metabolism, infectivity, and the like. Destruction can be accomplished by altering the reaction kinetics of biological processes within the local area treated with the ultrasound at resonant frequencies. The reaction kinetics of a target material or healthy tissue surrounding a target material can be modified to achieve a desired end. For example, altering the reaction kinetics of a biological process can include increasing the production of toxic metabolites while leaving the subsequent disposal pathway unaffected, thereby destroying a target material organism; increasing mRNA degradation to inhibit transcription; affecting some aspect of the target containing material metabolism to stimulate a beneficial immune response; or creating a local environment unsuitable for a target material pathogen.

Alternatively, while not wishing to be bound by any theory, it is believed that application of ultrasound tuned to the specific resonance frequency of a target material causes a change in the target material so that well hidden antigenic components become less well hidden. That is, in some instances the application of ultrasound tuned to the specific resonance frequency of a target material changes the conformation of the target material (or changes the conformation of a portion of the target material) whereby previously obstructed antigenic components of the target material are more easily accessible to materials that would otherwise not detect or bind to the antigenic components. In this context, change in the target material refers to a change that directly or indirectly leads to destruction or inactivation of a target material or of one or more components of the target material.

A change in structural conformation which better presents previously well hidden antigenic components has at least two advantages. First, an antigenic component that is presented or more easily accessible makes the antigens on the surface more available which in turn better stimulates an immune response compared to the same well hidden antigen on a target material not subject to the application of ultrasound tuned to a specific resonance frequency. Second, an antigenic component that is presented or more easily accessible makes the antigens on the surface more available which in turn makes antigenic tags visible broadly for later recognition and destruction by materials of the immune system of a living body.

In one embodiment, application of ultrasound tuned to the specific resonance frequency of a target material that causes a change in the target material so that well hidden antigenic components become less well hidden constitutes a method of stimulating the immune system of a living body. Recognition of pathogens can be increased by making well hidden antigenic components of the pathogens or target material become less well hidden. These functions of DCs are largely dependent on The expression of specialized surface receptors or pattern recognition receptors is to alert dendritic cells to produce compounds for initiating immune responses, such as interleukin 12 (IL-12) and other inflammatory cytokines. Making well hidden antigenic components of the pathogens or target material become less well hidden can contribute to the activation of immune cells.

In another alternative, while not wishing to be bound by any theory, it is believed that application of ultrasound tuned to the specific resonance frequency of a microsphere or other particle containing a pharmaceutical effective to destroy a target material causes release of the pharmaceutical in the locale of the ultrasound application. A variety of natural and synthetic polymers can be used to encapsulate pharmaceutical or other agents. The polymers produce are typically biocompatible and are not contaminated by biological materials of the living body.

In another embodiment, application of ultrasound tuned to the specific resonance frequency of a microsphere or other particle containing a pharmaceutical constitutes another use of ultrasound as a drug delivery tool to destroy pathogens or target materials. Targeting releasing of pharmaceutical or other agents effective to destroy target materials using ultrasound tuned to the specific resonance frequency of a microsphere or other particle activates the pharmaceutical or agents locally.

Examples of target materials include DNA, RNA, proteins, carbohydrates, lipids, lipopolysaccharides, glycolipids, glycoproteins, proteoglycans, chloroplasts, mitochondria, endoplasmic reticulum, cells, organs, viruses, bacteria, protozoans, parasites, fungi, worms, mollusks, arthropods, tissue masses, cancer cells/tissues, tumors, cysts, fibrosis, mucous, otherwise diseased tissue, and the like. Target materials are often associated with a disease that can be treated in accordance with the systems and methods described herein.

The target materials can be separated and isolated from a living body, present in a living body, or present in a biological sample obtained from the living body. For example, biological samples include blood, plasma, bone marrow, muscle tissue, fat tissue, and the like. The treated biological samples can be returned to the same living body from which they were obtained or provided to another living body.

In the case of virulent organisms, the virulence factors may be specifically targeted for disruption to prevent or inhibit the growth, infectivity or virulence of the organism. Such virulence factors include endotoxins, exotoxins, pili, flagella, proteases, ligands for host cell receptors, capsules, cell walls, spores, chitin, and the like. For example, the spikes on an HIV virus, which are believed to facilitate entry of HIV into human cells, can be destroyed thereby preventing HIV from entering human cells even though HIV may be present in a human body.

The resonant frequency of the target material can be known or determined to provide an initial level of appropriate ultrasound energy for inducing resonance in the target material. The resonant frequency of material surrounding the target material must also be known or determined to provide the appropriate ultrasound energy for inducing resonance in the target material without deleteriously affecting the surround material. In other words, determining the specific frequency and/or frequencies that induce resonance in target materials and materials surrounding target materials provide acoustic signatures that can be stored in memory as reference signatures for subsequent processing. The target material can be induced into resonance by introducing or applying ultrasound energy including at least one resonant frequency from the stored acoustic signatures and modified depending on other factors if necessary.

The application of ultrasound energy including a resonant frequency can be applied in either continuous and/or periodic form depending on the desired effects. That is, the ultrasound energy is directed at a target material continuously and/or intermittently (pulsed).

The ultrasound application can be performed with or without the use of one or more of drugs, radiowaves (RF) or electromagnetic radiation (EM). In one specific embodiment, the ultrasound application is performed without the use of any other stimulus, such as RF or EM, and the like.

In another embodiment of the present invention a system for disrupting a target material involves applying ultrasound energy at a narrow band of resonant frequencies including a resonant frequency previously determined and stored in a memory to induce resonance in the target material, the ultrasound energy applied at a sufficient power input to destroy the target material without deleteriously affecting surrounding tissue.

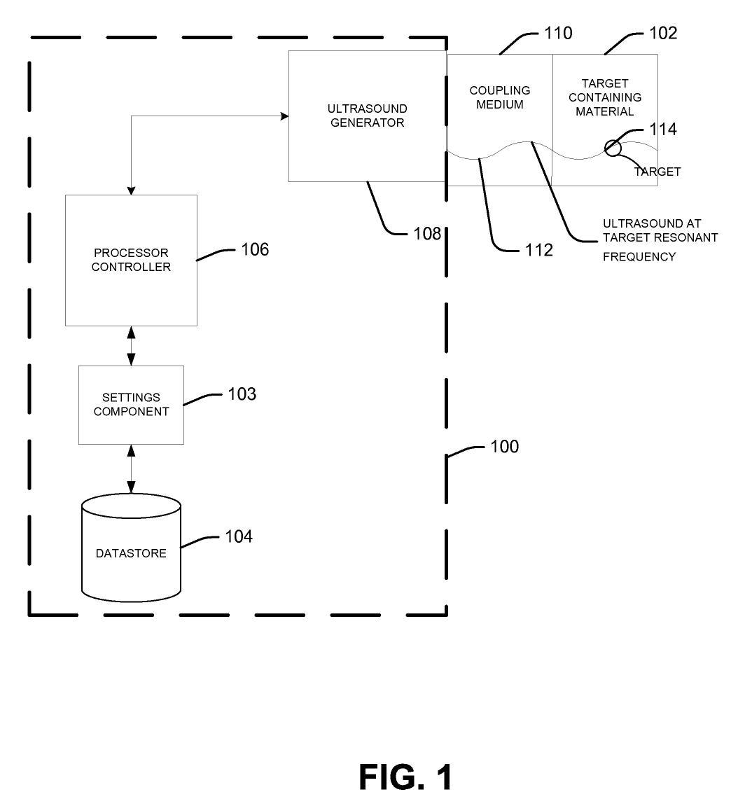

Referring to FIG. 1, a high level schematic diagram illustrates the systems and methods of disrupting or destroying target material with select frequencies but not detrimentally effecting surrounding structures or tissues within a living body. FIG. 1 depicts a system 100 that delivers ultrasound energy 112 to a target material 114 at resonant frequency tuned to a resonant frequency of the target material. The system 100 includes an ultrasound generator 108 capable of producing ultrasound energy within a narrow band of select frequencies.

The ultrasound generator 108 is any device capable of generating and transmitting ultrasound energy optionally through a coupling medium can be used to generate the resonant frequencies. For example, ultrasound energy can be produced by a transducer that converts received electromagnetic energy into rapid, physical vibrations, and thus ultrasound energy. Transducers can employ the piezoelectric properties of naturally occurring quartz to produce ultrasound energy waves; ferroelectric ceramics (barium titanate, lead titanate, or lead zirconate) and zinc oxide; and piezoelectric polymers. Transducers are also commercially available from a wide variety of manufacturers, in a wide variety of designs which can be configured to particular applications and frequencies. The transducers can produce an ultrasound wave within a narrow range of frequencies or for one specific frequency.

Any suitable ultrasound device that produces a signal with predetermined characteristics such as frequency, mode, pulse duration, shape, and repetition rate may be utilized to generate the resonant acoustic frequencies utilized herein. Ultrasound equipment manufactures include Acuson, Aloka and ATL Ultrasound, (aquired and currently called Philips Ultrasound), B-K Medical A/S, Esaote Biomedica, GE Ultrasound, Hewlett Packard, Krotz, Medison, Siemens, Shimadzu, Toshiba, Hitachi Medical Systems, Honda Electronics, SonoSite, Kontron Medical, Fukuda Denshi, and others.

A processor-controller component 106 is coupled to the ultrasound generator 108. The processor-controller component 106 controls the operational parameters of the ultrasound generator 108, such as the frequency, power, duration, and the like. The processor-controller component 106 is also coupled to a settings component 103, which in turn, is coupled to a datastore 104.

The settings component 103 and datastore 104 facilitate determining the operational parameters of the ultrasound generator 108 so that ultrasound energy 112 at a select resonant frequency tuned to the resonant frequency of a target material 114 can be produced by the ultrasound generator 108. The settings component 103 and datastore 104 store and/or consider one or more of various factors for selecting a resonant frequency. For example, one or more of the identity of the target material 114, the depth of the target material 114 within the target containing material 102, the identity of materials through which the ultrasound 112 passes between the ultrasound probe/transducer 108 and the target material 114, the number of material boundries or tissue interfaces in the target containing material 102 through which the ultrasound 112 passes between the ultrasound probe/transducer 108 and the target material 114 are considered when selecting a specific resonant frequency.

A target containing material has within it a target material, which is the recipient of ultrasound energy tuned to its resonance frequency. Examples of target materials include living bodies and samples (such blood samples, tissue samples, organs, plasma samples, bone marrow samples, and the like) from living bodies. Living bodies are organisms that contain a target material. An example of a living body is a human being, although additional examples include other non-human mammals such as pets, livestock, and plants.

Ultrasound energy waves can be transmitted into gaseous, liquid, or solid media either by direct contact of the transducer with the living body or sample containing the target material, or by an optional coupling medium 110. In the case of a living body, coupling through a coupling medium is often employed since the ultrasound wave travels through multiple layers of tissue before reaching its target material. If the target material is a liquid, a transducer can be placed into the liquid in direct contact, or the liquid can be placed in a container whose walls are themselves transducers, in direct contact with the liquid. Also, a transducer can be placed on the outside of the walls of a container in which the liquid is placed.

If the target material is a solid, a transducer can be placed in direct contact. The solid can be placed in a gas or liquid which is used as a coupling medium. A liquid or gel-type coupling medium can also couple between a free-standing solid and a transducer, when the transducer is placed on a surface of the solid. Due to the acoustic impedance difference between air and skin, a transducer is coupled to the skin of a living body via a coupling medium to better match the impedance of the crystal in the transducer more closely to the impedance of the skin or other part of the living body.

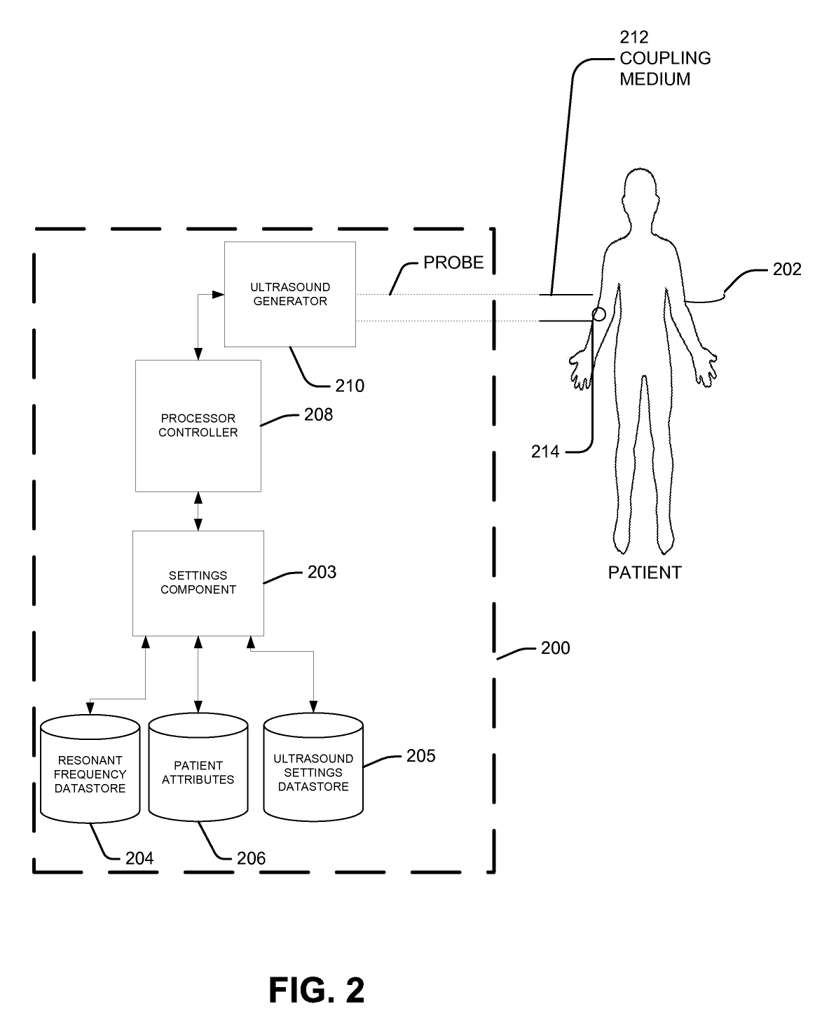

Referring to FIG. 2, a schematic diagram illustrating an aspect of the systems and methods of disrupting or destroying target material with select frequencies but not detrimentally effecting surrounding structures or tissues within a living body is depicted. FIG. 2 depicts a system 200 that delivers ultrasound energy to a target material 214 in a living body 202 at resonant frequency tuned to a resonant frequency of the target material 214. The system 200 includes an ultrasound generator 210 capable of producing ultrasound energy within a narrow band of select frequencies.

A processor-controller component 208 is coupled to the ultrasound generator 210. The processor-controller component 208 controls the operational parameters of the ultrasound generator 210, such as the frequency, power, duration, and the like. The processor-controller component 208 is also coupled to a settings component 203, which in turn, is coupled to a resonant frequency datastore 204, a patient attribute datastore 206, and an ultrasound settings datastore 205.

The settings component 203 using information in the resonant frequency datastore 204, a patient attribute datastore 206, and an ultrasound settings datastore 205 facilitates determining the operational parameters of the ultrasound generator 210 so that ultrasound energy at a select resonant frequency tuned to the resonant frequency of a target material 214 can be produced by the ultrasound generator 210. The settings component 203 initially considers the resonant frequency of a target material which is stored in a resonant frequency datastore 204.

The resonant frequency datastore 204 contains resonant frequencies of various target materials or can be populated to contain the resonant frequencies of various target materials (or the resonant frequencies of portions target materials such as peplomers). In this connection, the systems and methods described herein further include methods for determining resonant frequencies of a target material and saving such resonant frequencies in a lookup table or data store. The resonant frequency of a target material can be determined by performing resonant acoustic spectroscopy using methods and systems known in the art. For example, a resonant frequency of a specific target material can be determined by applying acoustic energy to the target material and scanning through a range of acoustic energy frequencies; and detecting at least one specific frequency which causes a maximum signal output from the target material indicating the target material is induced into its resonant frequency by the at least one specific frequency.

The resonant frequency datastore 204 can also contain resonant frequencies of various target containing materials, and surrounding materials within the target containing material. The resonant frequencies of target materials and the target containing materials (and materials within) facilitate comparisons that ensure that the resonant frequencies employed to destroy target materials are sufficiently different from the resonant frequencies of surrounding materials.

The specific frequencies causing the maximum signals are the resonant frequencies of the target materials that constitute the acoustic signature of the target material. Once determined, at least one resonant frequency may be applied to the target material to disrupt or destroy the target material.

Acoustic signature is an energy pattern of an object in resonance in frequency to the resonant frequency. Acoustic spectroscopy involves detecting a unique signature for a target material or surrounding tissue that is in resonance, which can be used to detect and/or identify the target material in resonance.

The frequency at which resonance occurs depends on the size, shape, and composition of a target material. For instance, the resonant frequency of a sphere is the frequency at which the acoustic wavelength is equal to the sphere diameter. A more complex structure such as a cylinder has two resonant frequencies based on two axes of orientation, with one of the resonant frequency wavelengths being equal to 1.5 times the length. The more complex the shape of the structure, the more complex the resonant frequency pattern. Nevertheless, in many instances, the wavelength at which resonance occurs is roughly equivalent to the size of the target material.

The frequency which matches a particular acoustic wavelength depends on the composition of the target material, according to the general equation:

velocity=frequency×wavelength

where velocity refers to the speed of the acoustic wave propagation (the speed of sound) in the medium leading to the target material. Although the speed of sound varies among various biological tissues, it is roughly equivalent to the speed of sound in water (1,500 m/s), since most living bodies or body samples mainly contain water. Using the speed of sound in water as the velocity of the acoustic wave, and using the target material size as the rough equivalent of the wavelength, the approximate range of resonant frequencies in target materials and surrounding substances can be determined. Known speeds of sound in specific tissues of a living body include: liver at about 1550 n/s; muscle at about 1580 n/s; fat at about 1459 n/s; brain at about 1560 m/s; kidney at about 1560 m/s; spleen at about 1570 m/s; blood at about 1575 m/s; bone at about 4080 n/s; lung at about 650 m/s; lens of eye at about 1620 m/s; aqueous humor at about 1500 m/s; and vitreous humor at about 1520 m/s. Resonant frequency ranges for target materials comprised of tissues with acoustic velocities different from the speed of sound in water, are derived using the same equation (velocity/wavelength) and correlated to the charted ranges listed below, plus or minus, depending on the speed of sound in the target material and/or surround tissue.

Although velocity of ultrasound energy in a particular medium is for the most part constant, there is a small dependence of velocity on frequency due to dispersion. Thus, the resonant frequency(s) or at least the range of frequencies within which the resonant frequency can be found for a target material depend on its size, shape, and composition, and the specific frequency range under examination. Various approximate resonant frequencies for target materials are included in the following Table 1 (assuming speed of sound=1,500 m/s).

TABLE 1

| Target material | approx. size | | approx. resonant frequency | |
|---|---|---|---|---|
| lice | 1 | mm | 1.5 | MHz |
| plant cells | 100 | μm | 15 | MHz |
| mammal cells | 10 | μm | 150 | MHz |
| bacteria | 1 | μm | 1.5 | gHz |
| viruses | 100 | nm | 15 | gHz |
| proteins | 10 | nm | 150 | gHz |
| small molecules | 1 | nm | 1.5 | tHz |

The systems and methods of destroying a target material involve delivering tuned ultrasound energy at resonant frequencies to target materials. For example, the qualitative and quantitative resonant frequencies can be determined in vitro. For example, a drop of fluid (whole blood, serum, culture fluid, or host cells, etc.) with known resonant frequency characteristics, and which also contains a known target material, is placed on a thin disc of absorptive media with known resonant frequency characteristics (paper, cellulose, cotton, polymer, etc.). A thin slice of target material containing tissue or material can be used. The disc is placed between two broadband low GHz or high MHz transducers and secured.

A range of frequencies for qualitative target material resonance signatures are derived using the speed of sound in biological tissues 1,500 m/s divided by desired wavelength, based on target material dimensions. If the target material dimensions are unknown, they may be determined by optical or digital microscopy or electron microscopy using techniques known in the art.

For example, a range of frequencies for target material resonance signatures the can be obtained in the following manner. A test disc containing a known target material is subjected to the following analysis. One ultrasound transducer generates an ultrasound signal and sweeps through a wide band of target frequencies, and another transducer detects the transmitted ultrasound signal. The ultrasound signal transmitted from the target material test disc/slice is fed into the positive lead of a signal analyzer. The known ultrasound signals from the test fluid and disc, or test embedding material serve as a control and are fed into the negative lead of the signal analyzer. The control signatures are canceled out and the remaining resonant frequency signature displayed is from the target material in the sample, yielding a qualitative result.

By varying the range of frequencies analyzed and comparing the amplitudes at each frequency, it is possible to identify the primary resonant frequencies, and the associated harmonic resonant frequencies. The primary resonant frequencies typically have the highest amplitude. Each target material may have multiple primary frequencies depending on target material dimensions including the diameter, length (if cylindrical or helical), apical distance, and unit distance. Table 2 contains approximate values of primary resonant frequencies for individual target materials, using acoustic velocity as 1,500 m/s, and target material dimensions as currently determined by standard methods. Results may and will vary in practice depending on specific target material factors such as bulk modulus, dispersion, acoustic velocity in target material, in vivo versus in vitro dimensions, and the like, and thus the frequencies are merely representative, approximate, and exemplary.

TABLE 2

| VIRUS | FREQUENCY (Hz) |
|---|---|
| Parvovirus | 7.143 × 10¹⁰ |
| Polyomavirus | 3.75 × 10¹⁰ |
| Papillomavirus | 3.33 × 10¹⁰ |
| Herpesvirus | 1.57 × 10¹⁰ |
| Bovine herpes virus | 1.57 × 10¹⁰ |
| Herpesvirus IV virus | 1.57 × 10¹⁰ |
| Herpesvirus V virus | 1.57 × 10¹⁰ |
| Adenovirus | 2.14 × 10¹⁰ |
| Vaccinia | 7.5 × 10⁹ |
| Variola | 7.5 × 10⁹ |
| Smallpox | 6.0 × 10⁹ |
| Cowpox Virus | 7.5 × 10⁹ |
| Molluscum | 7.5 × 10⁹ |
| Contagiosum | 6.0 × 10⁹ |
| ORFVirus | 1.0 × 10¹⁰ |
| Paravaccinia | 1.0 × 10¹⁰ |
| Hepatitis B | 3.75 × 10¹⁰ |
| Calicivirus | 4.84 × 10¹⁰ |
| Picornavirus | 6.00 × 10¹⁰ |
| Reovirus | 2.14 × 10¹⁰ |
| HIV | 1.76 × 10¹⁰ |
| Influenza | 1.88 × 10¹⁰ |
| Parainfluenza | 1.66 × 10¹⁰ |
| Paramyxovirus | 1.66 × 10¹⁰ |
| Respiratory Syncytial Virus | 1.25 × 10¹⁰ |
| Marburg virus | 1.88 × 10¹⁰ |
| Ebola Virus | 1.88 × 10¹⁰ |

Once the qualitative target material resonant acoustic signature is determined, quantitative results may be determined by comparing the resonant acoustic signature amplitudes from samples of known concentrations of a specific target material. Samples with higher target material loads (concentrations) generally have higher resonant acoustic signature amplitudes. A ratio of primary resonant frequency amplitude to target material concentration is thus derived, allowing for assessment of target material load in samples of unknown concentration.

In another embodiment, resonant acoustic signatures from the test disc/slice may be generated either by first clamping a control disc/slice into the transducer chamber and storing the resonant acoustic signature in a microprocessor for subsequent processing with the test disc/slice signature, or by clamping a control into a second transducer chamber and sweeping through the wide band of frequencies simultaneously with the test disc/slice virus sweep. Also, the test disc/slice may be clamped between the transducer and a reflective surface, and the ultrasound wave generated and received by the same transducer, thus analyzing reflected rather than transmitted ultrasound waves. Furthermore, one or more transducers analyzing reflected or transmitted ultrasound energy may by immersed into a fluid or medium containing the target material.

The effects of the resonant frequencies can be determined in vitro. Using standard culture methods, known to those skilled in the art, the target material culture may be placed in a reusable/autoclavable test cylinder. The bottom surface of the test cylinder is the transducer, constructed for the appropriate frequencies, such as a thin film zinc oxide on a sapphire substrate. The host medium thus placed in the test cylinder spreads over the bottom of the cylinder in a monolayer and in direct contact with the transducer. Ultrasound energy of the desired resonant frequency is then delivered through the culture fluid and host medium to the target materials, and the effects on growth and function are assessed using standard methods. By varying the ultrasound wave characteristics, such as amplitude, mode (continuous vs. pulsed), shape (sinusoidal vs. square), intensity etc., the ideal frequency and waveform required to obtain specific effects can be determined.

For example, in testing the destruction of resonant ultrasound frequencies on HIV, uninfected T-lymphocyte host cells are first assessed in the test cylinder with the resonant ultrasound intervention (resonant frequencies in varying waveform patterns for varying periods of time at varying intensities) using a trypan blue dye exclusion test, which excludes anomalous viral results by assessing the effects of the ultrasound intervention on the host cells alone. Next, a calculated number of HIV infected T-lymphocytes are placed in the test cylinder. The host cells form a monolayer on the transducer/floor of the test cylinder, where the ultrasound intervention is delivered. The results are then assessed using standard in vitro methods such as the Coulter HIV-1 p24 antigen kit, HIV cultures, HIV-1 DNA by PCR, viral load measurement, quantitative measurements, time to positivity, and growth suppression.

Since the induction of resonance in a target material can lead to sudden and irreversible structural failure due to rupture of one or more components of the target material, target materials can be selectively disrupted using resonant ultrasound energy. Many biochemical compounds and biologic structures are naturally occurring crystals and especially susceptible in that regard to the effects of resonant acoustic energy. The rigid, crystalline structure of viruses facilitates the physical disruption of the virion structure using ultrasound energy at the resonant frequencies unique to each specific virus.

There are two major types of virus symmetry—icosahedral and helical. The icosahedral shape is roughly equivalent to a soccer ball, while the helical shape looks like a toy slinky. The majority of viruses fall into one of these groups, the remainder being complex or unknown. The icosahedral is roughly a spherical shape made up of 20 identical, equilateral triangles, with 3 axes of five-fold symmetry. In the helix, the units of the capsid spiral out around the nucleic acid, which runs down the center of the virus, and there is only one axis of spiraling symmetry.

Within each symmetry group, viruses can further be separated into DNA and RNA groups. Viruses have a central core of nucleic material, either DNA or RNA. The nucleic core is typically surrounded by a symmetrical protein shell, called a capsid. The capsid is composed of individual capsomere morphological units, which are in turn composed of individual structural units. The individual structural units in some instances are referred to as crystallographic units, due to a repeating pattern demonstrated with X-ray crystallographic diffraction techniques. Structural units are the building blocks of the virus structure and are typically identical proteins.

In some viruses, a lipoprotein membrane surrounds the capsid. The envelope is often derived from host cell membranes and is modified by the virus during its departure from the host cell. The envelope may carry specific virus proteins such as hemagglutinin or neuramimidase that facilitate future functions. The envelope of some viruses is studded with projections, or peplomers. The peplomers contribute to the survival of the virus and in some instances allow the virus to penetrate healthy cells. Application of ultrasound tuned to about the resonant frequency of a peplomer of a given virus can destroy the peplomer and thereby render the virus harmless by inhibiting the ability to penetrate healthy cells. Specifically in the case of HIV, which is believed to enter healthy cells by means of peplomers, the ultrasound treatments described herein offer effective countermeasures to cellular viral infection.

The patient attribute datastore 206 stores one or more of various factors associated with a target containing material such as a patient for selecting or modifying a resonant frequency. Examples of factors unique to a specific patient include percent body fat, medical history, sensitivity to ultrasound, food/fluids recently consumed, the presence of non-target materials that may have resonant frequencies relatively close to those of the target material, current temperature, current pressure, ultrasound machine generator unique attributes, and the like.

The ultrasound settings datastore 205 stores one or more of various factors associated with delivering ultrasound to the target material for selecting or modifying a resonant frequency. For example, one or more of the depth of the target material within the target containing material, the identity of materials through which the ultrasound passes between the ultrasound probe/transducer and the target material the number of material boundries or tissue interfaces in the target containing material through which the ultrasound passes between the ultrasound probe/transducer and the target material are considered when selecting or modifying a specific resonant frequency.

The exact fraction of the incident ultrasound which is transmitted to the target material or reflected depends on how many different materials the ultrasound passes through, the differences between two materials on each side of a boundary, and the depth of the target material. The fraction of ultrasound which is transmitted to the target material is described by the acoustic impedance of the materials through which the ultrasound passes, which is related to the density of each material and the speed of ultrasound in each material. Generally speaking, the greater the difference in impedance between two materials, a greater amount of ultrasound is reflected rather than transmitted. Typical impedances are reported in Table 3 below.

TABLE 3

| Medium/material | Impedance (in standard units) |
|---|---|
| air | 0.000429 |
| water | 1.50 |
| blood | 1.59 |
| fat | 1.38 |
| muscle | 1.70 |
| bone (average) | 6.5 |
| soft tissue | 1.63 |
| brain | 1.58 |

In one embodiment, an ultrasound transducer is placed adjacent the living body or the portion of the living body under treatment (optionally with a coupling medium therebetween) for direct application ultrasound waves. In another embodiment, the living body or the portion of the living body under treatment is immersed in a conductive medium and ultrasound waves are applied through the medium to the living body or portion thereof at a resonant frequency to cause resonance and destruction of the target material infecting the living body. In yet another embodiment, a sample containing a target material (a fluid sample such as blood or a tissue sample) is withdrawn from the living body and subjected to ultrasound treatment, then retuned to the living body. Withdrawal of the sample can be conducted on a continuous or batchwise basis.

In one specific aspect, an ultrasound transducer is placed adjacent to a limb of a living body in order to focus on one or more vascular pathways (such as the brachial artery or the radial artery), optionally with a coupling medium therebetween, for application of ultrasound waves to blood travelling through the particular vascular pathway. Focused application of ultrasound on a limb or other portion of a living body eliminates the need for an invasive withdrawal and replacement of a biological fluid. In another aspect, the ultrasound transducer can be guided over a limb or other portion of a living body during application of ultrasound waves.

The duration of the treatment or application of ultrasound tuned to narrow band of frequencies is sufficient to achieve destruction of at least some of the target material, without any substantial harm to nearby structures or healthy tissues/cells. The duration of the treatment is sufficient to destroy at least about 25% of the target material present yet have little or no harmful side effects to the living body. In another embodiment, the duration of the treatment is sufficient to destroy at least about 50% of the target material present yet have little or no harmful side effects to the living body. In yet another embodiment, the duration of the treatment is sufficient to destroy at least about 99% of the target material present yet have little or no harmful side effects to the living body.

The ultrasound energy, including the resonant frequencies may be applied at a power level sufficient to destroy the target material. Depending on the power intensity of the ultrasound energy, the characteristics of a living body or substance in which a target material is present, and the characteristics of the target material targeted, the target material can be destroyed or have its functions affected, such as have its functions rendered inoperable. Depending on the size, shape, and composition of the target material, there can be more than one naturally occurring resonant frequency, as well as numerous subharmonic and superharmonic resonant acoustic frequencies.

The application of ultrasound tuned to the specific resonance frequency of a target material is particularly useful when power levels that specifically affect the target material have virtually no detrimental effects on surrounding, nonresonant structures or surrounding structures having different specific resonance frequencies. The power intensity is dependent upon the nearby or surrounding tissue, target material, location/depth of the target material. In one embodiment, the power intensity is from about 0.01 to about 1×10^{11 W/m}². In another embodiment, the power intensity is from about 10 to about 100,000 W/m². In yet another embodiment, the power intensity is from about 100 to about 10,000 W/m².

Specific frequencies that create resonance in specific target materials causes the destruction of the target materials, but not healthy, adjacent or surrounding tissues. The disruption of target materials is useful to treat multicellular organisms, in particular, animals, including mammals, birds, plants, fruit, insects, arthropods, and the like or portions thereof which are susceptible to infection by or diseases of target materials. Portions of a multicellular organism which may be treated for destruction of target materials include whole body, limbs, organs such as the kidney, spleen, liver, pancreas, heart, lung, gastrointestinal tract, and the like, tissue such as the cornea, bone, bone marrow, blood, cartilage and the like. Products derived from the multicellular organism such as blood products may be treated.

In the case where the living body is infected with more than one genus or species of target material, it is desirable to treat the living body with a resonant frequency specific to destroy each type of target material infecting the living body. As in the case of a human infected with HIV-1, opportunistic infections may occur caused by such viruses as cytomegalovirus, adenovirus, Herpes Simplex virus, and the like. In such a case, the unique resonant frequency may be applied for each target material infecting the living body.

The treatment methods described herein are beneficial in organ and/or tissue transplantation. Treatment of organs and/or tissues from a donor prior to transplantation prevents or inhibits the transmission of disease-causing viruses and other target materials to the recipient. Such a method is useful in xenotransplants, allogeneic transplants, syngeneic transplants and the like. Donor organ and/or tissue for treatment include cornea, heart, liver, lung, skin, bone, bone marrow tissue/cells, blood and blood products, kidney, pancreas, and the like.

Examples of diseases caused by retroviruses which may be inhibited or treated using the methods described herein include AIDS, leukemia, mouse mammary tumor, sarcoma and the like. Examples of diseases caused by Hepadna viruses include Hepatitis B, Hepatitis C, liver cancer, woodchuck hepatitis, ground squirrel hepatitis, duck hepatitis, and the like. Examples of diseases caused by Herpes viruses which may be prevented, inhibited or treated using the methods described herein include genital and oral herpes, chickenpox, shingles, cytomegalovirus disease (birth defects and pneumonia), mononucleosis, Burkitt's lymphoma, nasopharyngeal cancer, bovine mammillitis, pseudorabies, and the like. Examples of diseases caused by Pox viruses which may be prevented, inhibited or treated using the methods described herein include smallpox, cowpox, pseudocowpox, molluscum contagiosum, contagious pustular dermatitis, buffalopox, camelpox, monkeypox, rabbitpox, mousepox, bovine papular otomatitis, fowlpox, turkeypox, sheeppox, goatpox, harepox, squirrelpox, swinepox and the like.

Examples of diseases caused by Papova viruses which may be prevented, inhibited or treated using the methods described herein include human wart virus, genital warts, cervical cancer, progressive multifocal leukoencephalopathy, warts and tumors in mice, monkeys and rabbits. Examples of diseases caused by Adenovirus which may be prevented, inhibited or treated using the methods described herein include upper respiratory tract infections, gastroenteritis, conjunctivitis and tumors. Examples of diseases caused by Parvo viruses amenable to prevention, inhibition or treatment using the methods described herein include Fifth disease, bone marrow failure, Rheumatoid arthritis, fetal death and low birth weight, feline leukemia, and the like. Examples of Picoma virus related diseases which may be prevented, inhibited or treated using the methods described herein include polio, Hepatitis A, common cold, foot and mouth disease, encephalitis, myocarditis, enteritis, swine vesicular disease, contagious vesicular disease, and the like. Examples of diseases caused by Reo viruses amenable to prevention, inhibition or treatment using methods described herein include upper respiratory tract infections, Colorado tick fever, gastroenteritis, and the like. Examples of Orthomyxo virus related diseases which may be prevented, inhibited or treated using the methods described herein include influenza of man, pigs, horses, seals, birds and the like.

Other examples of diseases caused by viruses which may be prevented, inhibited or treated using the methods described herein include viral diarrhea, infantile gastroenteritis, vesicular exanthema of swine, sea lion disease encephalomyelitis, Dengue fever, yellow fever, rubella, equine encephalomyelitis, hog cholera, Bwamba fever, Oriboca fever, Rift Valley fever, Congo hemorrhagic fever, Nairobi sheep disease, African swine fever, mumps, measles, ebola, polio, hairy cell leukemia, and the like.

The systems and methods involve destroying viruses in vivo in a portion of a living body (an arm as shown in FIG. 2), using a resonant ultrasound field probe. Ultrasound transducers of desired frequency are fitted into the end of a hand-held probe device, as currently known to those skilled in the art of medical ultrasonography. A predetermined ultrasound field (frequencies, harmonics, amplitude, mode, shape, etc. at the required intensity to affect the living body) is delivered to a predetermined portion of the living body, from the hand-held transducer probe. Attenuation in air is eliminated by use of a commercially available coupling medium such as castor oil. For example, in a person afflicted with hepatitis, the treatment is delivered through the skin over the liver. Subharmonics of the resonant frequencies can be used to minimize ultrasonic attenuation at the higher frequencies.

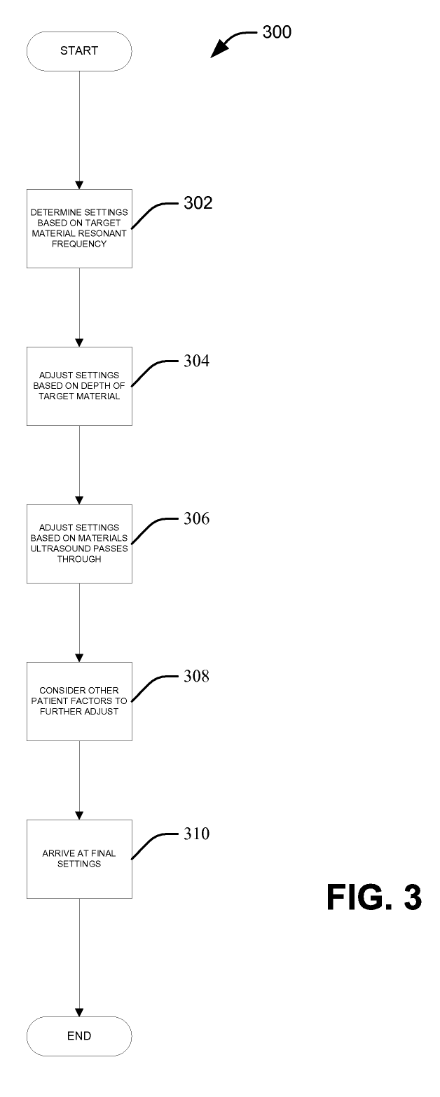

FIG. 3 is a flow diagram of one example of a method 300 of generating final settings for an ultrasound generator to deliver ultrasound tuned to the resonance frequency of a target material. Settings include frequency, power, intensity, duration or pulse length, and the like. The method 300 can be encoded by computer-executable instructions stored on computer-readable media. Processing begins at block 302 where settings are initially selected based upon the resonance frequency of a target material. Table 1 above provides exemplary data that may be considered to select initial settings. It is noted that two or more target materials can exist in a living body, and therefore, settings based upon the resonance frequency of two target materials can be selected. Furthermore, in some instances it may be desirable to select two different resonance frequencies for a single target material (many target materials have multiple resonance frequencies).

Processing proceeds to block 304 where the depth of the target material (or the distance or approximate distance of the target material from the ultrasound probe/transducer) is considered to modify the initial ultrasound generator settings. In this connection, it is noted that generally speaking the lower the frequency of sound waves, the deeper the penetration into any given material.

Processing proceeds to block 306 where the identity of materials through which the ultrasound passes between the ultrasound probe/transducer and the target material is considered to modify the ultrasound generator settings. Table 2 provides exemplary data that may be considered to modify the initial or modified settings. In addition to considering the identity of materials through which the ultrasound passes between the ultrasound probe/transducer and the target material, block 306 can further contemplate consideration of the number of material boundries or tissue interfaces in the living body or sample through which the ultrasound passes between the ultrasound probe/transducer and the target material.

Processing proceeds to block 308 where factors unique to a patient or living body are considered to modify the ultrasound generator settings. Examples of factors unique to a specific patient include percent body fat, medical history, sensitivity to ultrasound, food/fluids recently consumed, the presence of non-target materials that may have resonant frequencies relatively close to those of the target material, current temperature, current pressure, ultrasound machine generator unique attributes, and the like.

It is noted that acts embodied by blocks 304, 306, and 308 can be practiced in any order, sequentially or simultaneously. Moreover, it is noted that only two of the three acts embodied by blocks 304, 306, and 308 can be practiced in order modify the initial ultrasound generator settings. Employing only two of three modification acts is effective when a relatively high likelihood exists that the unperformed modification act will not substantially modify the initial ultrasound generator settings, or when relatively fast processing is of paramount concern. It is further noted that only one of the three acts embodied by blocks 304, 306, and 308 can be practiced in order modify the initial ultrasound generator settings. Employing only one of three modification acts is effective when a relatively high likelihood exists that the two unperformed modification acts will not substantially modify the initial ultrasound generator settings or modified settings, or when relatively fast processing is of paramount concern.

At block 310, final settings are determined based on all considerations. It is noted that arriving at the final settings is dynamic and the analysis selected and implemented can vary as a function of numerous parameters; and thus the method 300 is adaptive.

The method 300 optionally includes methods for capture of logical relationships such as theorem provers or more heuristic rule-based expert systems. Inferences derived from such learned or manually constructed models can be employed in setting selection, such as linear and non-linear programming, that seek to maximize some objective function.

The settings component can optionally take into consideration historical data, and data about current context. Policies can be employed that consider including consideration of the cost of making an incorrect determination or inference versus benefit of making a correct determination or inference. Accordingly, an expected-utility-based analysis can be used to provide inputs or hints to other components or for taking automated action directly. Ranking and confidence measures can be calculated and employed in connection with such analysis.

The systems and methods of destroying a target material may also be utilized in agricultural settings. For example, plants, fruits, vegetables, and the like, suspected of containing a target material or disease causing viruses may be treated using tuned resonant ultrasound energy for destruction of the viruses. Portions of plants which may be treated for destruction of a virus include seeds, seedling, pulp, leaves, vegetables, fruits, and the like.

The systems and methods involve destroying target materials extracorporeally and/or intravascularly in a living body using resonant frequencies. For example, in humans infected with HIV, an extracorporeal blood circulation system is established using techniques known to those in the art. The extracorporeal blood is passed over one or more transducers.

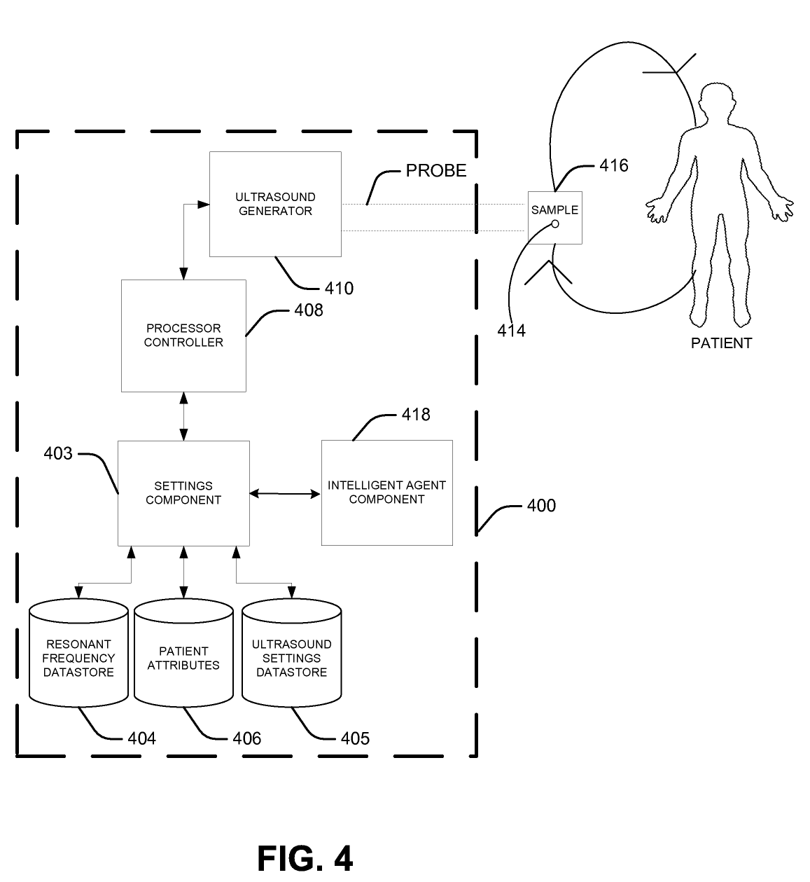

Referring to FIG. 4, a system 400 is depicted that provide destruction of viruses or other target materials extracorporeally. System 400 delivers ultrasound energy to a target material 414 in a body fluid sample 416 at resonant frequency tuned to a resonant frequency of the target material 414. The system 400 includes an ultrasound generator 410 capable of producing ultrasound energy within a narrow band of select frequencies.

A processor-controller component 408 is coupled to the ultrasound generator 410. The processor-controller component 408 controls the operational parameters of the ultrasound generator 410, such as the frequency, power, duration, and the like. The processor-controller component 408 is also coupled to a settings component 403, which in turn, is coupled to a resonant frequency datastore 404, a patient attribute datastore 406, and an ultrasound settings datastore 405.

The settings component 403 using information in the resonant frequency datastore 404, a patient attribute datastore 406, and an ultrasound settings datastore 405 facilitates determining the operational parameters of the ultrasound generator 410 so that ultrasound energy at a select resonant frequency tuned to the resonant frequency of a target material 414 can be produced by the ultrasound generator 410.

A body fluid sample 416 (or tissue or organ sample) can be continuously or intermittently withdrawn from a patient as shown by the lower arrow, treated with ultrasound energy tuned to a resonant frequency of the target material 414, then returned to the patient as shown by the upper arrow.

For example, in humans infected with HIV, an extracorporeal blood circulation system is established using techniques known to those skilled in the art. The extracorporeal blood is passed over a series of reusable/autoclavable sterilized transducers that deliver ultrasound energy at primary or harmonic resonant frequencies. The ultrasound transducer series acts in effect as a filter, disrupting viruses in the blood stream. Efficacy of treatment is assessed using viral load studies, as known to one skilled in the art, both prior to and after the extracorporeal treatments.

The above described ultrasound filter is optionally fitted with a receiving transducer mode for analysis of the blood sample. With initial passes of blood containing large numbers of intact virus, the resonant amplitude is typically high. After prolonged exposure of the blood to the destroying resonant frequencies, the resonant amplitude declines as the numbers of intact viruses decrease, thus giving viral load readings and a method to determine when cessation of the extracorporeal treatment is indicated.

In another embodiment, banked blood is passed through an ultrasound filter at any one of multiple points in the blood product collection and administration process (i.e., collection from the donor, separation into components, or administration to the recipient).

The system 400 can include an intelligent agent component 418 that can be deployed on commercially available PLC's, PC's, SBC, etc. within or connected to the settings component 403. It is to be appreciated that the claimed subject matter can include multiple types of target materials 414, resonant frequencies, and/or multiple intelligent agent components 418. Moreover, it is to be understood that the intelligent agent component 418 can be a stand-alone component or incorporated into the settings component 403. The intelligent agent component 418 can provide holonic system capabilities and the eventual transition to autonomous agents, which can respond to unexpected detections/data, the ability to dynamically respond to the unexpected detections/data. The intelligent agent component 418 can allow highly distributed diagnostics to sense an unfavorable condition and prescribe a superior countermeasure.

The intelligent agent component 418 can utilize a suite of simulation, prototyping, and/or deployment tools in accordance with the subject innovation. By deploying the intelligent agent component 418, unprecedented target material destruction can be provided as well as consequent overall health benefits. The system 400 can significantly enhance the quality, target material destruction reliability, health, and ability to avoid deleteriously affecting living bodies. Furthermore, the real-time process information can be utilized for closed-loop feedback control, adaptive process model development, predictive treatment, and other intervention applications.

The intelligent agent component 418 can adhere to published agent-to-agent communication protocols (e.g., Foundation for Intelligent Physical Agents (FIPA)) and provide local intervention and decision-making along with more overall health goals. Although not shown, intelligent agent component 418 can be deployed in the system of FIG. 1 or FIG. 2.

It is to be understood that the intelligent agent component 418 can provide for reasoning about or infer states of the system, environment, target material, and/or target containing material from a set of observations as captured via events and/or data. Inference can be employed to identify a specific context or action, or can generate a probability distribution over states, for example. The inference can be probabilistic—that is, the computation of a probability distribution over states of interest based on a consideration of data and events. Inference can also refer to techniques employed for composing higher-level events from a set of events and/or data. Such inference results in the construction of new events or actions from a set of observed events and/or stored event data, whether or not the events are correlated in close temporal proximity, and whether the events and data come from one or several event and data sources. Various classification (explicitly and/or implicitly trained) schemes and/or systems (e.g., support vector machines, neural networks, expert systems, Bayesian belief networks, fuzzy logic, data fusion engines . . . ) can be employed in connection with performing automatic and/or inferred action in connection with the claimed subject matter.

The claimed subject matter can be implemented via object oriented programming techniques. For example, each component of the system can be an object in a software routine or a component within an object. Object oriented programming shifts the emphasis of software development away from function decomposition and towards the recognition of units of software called “objects” which encapsulate both data and functions. Object Oriented Programming (OOP) objects are software entities comprising data structures and operations on data. Together, these elements enable objects to model virtually any real-world entity in terms of its characteristics, represented by its data elements, and its behavior represented by its data manipulation functions. In this way, objects can model concrete things like people and computers, and they can model abstract concepts like numbers or geometrical concepts.

As used in this application, the terms “component” and “system” are intended to refer to a computer-related entity, either hardware, a combination of hardware and software, or software in execution. For example, a component can be, but is not limited to being, a process running on a processor, a processor, a hard disk drive, multiple storage drives (of optical and/or magnetic storage medium), an object, an executable, a thread of execution, a program, and/or a computer. By way of illustration, both an application running on a server and the server can be a component. One or more components can reside within a process and/or thread of execution, and a component can be localized on one computer and/or distributed between two or more computers.

Furthermore, all or portions of the claimed subject matter may be implemented as a system, method, apparatus, or article of manufacture using standard programming and/or engineering techniques to produce software, firmware, hardware or any combination thereof to control a computer to implement the disclosed subject matter. The term “article of manufacture” as used herein is intended to encompass a computer program accessible from any computer-readable device or media. For example, computer readable media can include but are not limited to magnetic storage devices (e.g., hard disk, floppy disk, magnetic strips . . . ), optical disks (e.g., compact disk (CD), digital versatile disk (DVD) . . . ), smart cards, and flash memory devices (e.g., card, stick, key drive . . . ). Additionally it should be appreciated that a carrier wave can be employed to carry computer-readable electronic data such as those used in transmitting and receiving electronic mail or in accessing a network such as the Internet or a local area network (LAN). Of course, those skilled in the art will recognize many modifications may be made to this configuration without departing from the scope or spirit of the claimed subject matter.

Some portions of the detailed description have been presented in terms of algorithms and/or symbolic representations of operations on data bits within a computer memory. These algorithmic descriptions and/or representations are the means employed by those cognizant in the art to most effectively convey the substance of their work to others equally skilled. An algorithm is here, generally, conceived to be a self-consistent sequence of acts leading to a desired result. The acts are those requiring physical manipulations of physical quantities. Typically, though not necessarily, these quantities take the form of electrical and/or magnetic signals capable of being stored, transferred, combined, compared, and/or otherwise manipulated.

It has proven convenient at times, principally for reasons of common usage, to refer to these signals as bits, values, elements, symbols, characters, terms, numbers, or the like. It should be borne in mind, however, that all of these and similar terms are to be associated with the appropriate physical quantities and are merely convenient labels applied to these quantities. Unless specifically stated otherwise as apparent from the foregoing discussion, it is appreciated that throughout the disclosed subject matter, discussions utilizing terms such as processing, computing, calculating, determining, and/or displaying, and the like, refer to the action and processes of computer systems, and/or similar consumer and/or industrial electronic devices and/or machines, that manipulate and/or transform data represented as physical (electrical and/or electronic) quantities within the computer's and/or machine's registers and memories into other data similarly represented as physical quantities within the machine and/or computer system memories or registers or other such information storage, transmission and/or display devices.

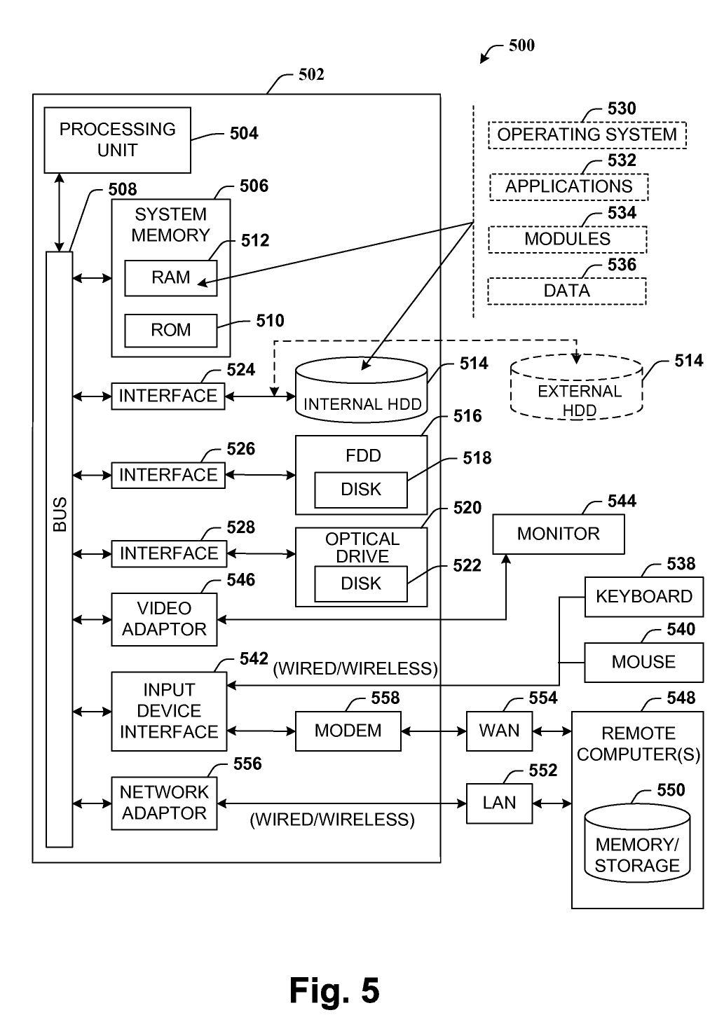

Referring now to FIG. 5, there is illustrated a block diagram of a computer operable to execute the disclosed system. In order to provide additional context for various aspects thereof, FIG. 5 and the following discussion are intended to provide a brief, general description of a suitable computing environment 500 in which the various aspects of the claimed subject matter can be implemented. While the description above is in the general context of computer-executable instructions that may run on one or more computers, those skilled in the art will recognize that the subject matter as claimed also can be implemented in combination with other program modules and/or as a combination of hardware and software.

Generally, program modules include routines, programs, components, data structures, etc., that perform particular tasks or implement particular abstract data types. Moreover, those skilled in the art will appreciate that the inventive methods can be practiced with other computer system configurations, including single-processor or multiprocessor computer systems, minicomputers, mainframe computers, as well as personal computers, hand-held computing devices, microprocessor-based or programmable consumer electronics, and the like, each of which can be operatively coupled to one or more associated devices.

The illustrated aspects of the claimed subject matter may also be practiced in distributed computing environments where certain tasks are performed by remote processing devices that are linked through a communications network. In a distributed computing environment, program modules can be located in both local and remote memory storage devices.

A computer typically includes a variety of computer readable media. Computer readable media can be any available media that can be accessed by the computer and includes both volatile and non-volatile media, removable and non-removable media. By way of example, and not limitation, computer-readable media can comprise computer storage media and communication media. Computer storage media includes both volatile and non-volatile, removable and non-removable media implemented in any method or technology for storage of information such as computer-readable instructions, data structures, program modules or other data. Computer storage media includes, but is not limited to, RAM, ROM, EEPROM, flash memory or other memory technology, CD ROM, digital video disk (DVD) or other optical disk storage, magnetic cassettes, magnetic tape, magnetic disk storage or other magnetic storage devices, or any other medium which can be used to store the desired information and which can be accessed by the computer.

With reference again to FIG. 5, the illustrative environment 500 for implementing various aspects includes a computer 502, the computer 502 including a processing unit 504, a system memory 506 and a system bus 508. The system bus 508 couples system components including, but not limited to, the system memory 506 to the processing unit 504. The processing unit 504 can be any of various commercially available processors. Dual microprocessors and other multi processor architectures may also be employed as the processing unit 504.

The system bus 508 can be any of several types of bus structure that may further interconnect to a memory bus (with or without a memory controller), a peripheral bus, and a local bus using any of a variety of commercially available bus architectures. The system memory 506 includes read-only memory (ROM) 510 and random access memory (RAM) 512. A basic input/output system (BIOS) is stored in a non-volatile memory 510 such as ROM, EPROM, EEPROM, which BIOS contains the basic routines that help to transfer information between elements within the computer 502, such as during start-up. The RAM 512 can also include a high-speed RAM such as static RAM for caching data.

The computer 502 further includes an internal hard disk drive (HDD) 514 (e.g., EIDE, SATA), which internal hard disk drive 514 may also be configured for external use in a suitable chassis (not shown), a magnetic floppy disk drive (FDD) 516, (e.g., to read from or write to a removable diskette 518) and an optical disk drive 520, (e.g., reading a CD-ROM disk 522 or, to read from or write to other high capacity optical media such as the DVD). The hard disk drive 514, magnetic disk drive 516 and optical disk drive 520 can be connected to the system bus 508 by a hard disk drive interface 524, a magnetic disk drive interface 526 and an optical drive interface 528, respectively. The interface 524 for external drive implementations includes at least one or both of Universal Serial Bus (USB) and IEEE 1094 interface technologies. Other external drive connection technologies are within contemplation of the claimed subject matter.

The drives and their associated computer-readable media provide nonvolatile storage of data, data structures, computer-executable instructions, and so forth. For the computer 502, the drives and media accommodate the storage of any data in a suitable digital format. Although the description of computer-readable media above refers to a HDD, a removable magnetic diskette, and a removable optical media such as a CD or DVD, it should be appreciated by those skilled in the art that other types of media which are readable by a computer, such as zip drives, magnetic cassettes, flash memory cards, cartridges, and the like, may also be used in the illustrative operating environment, and further, that any such media may contain computer-executable instructions for performing the methods of the disclosed and claimed subject matter.

A number of program modules can be stored in the drives and RAM 512, including an operating system 530, one or more application programs 532, other program modules 534 and program data 536. All or portions of the operating system, applications, modules, and/or data can also be cached in the RAM 512. It is to be appreciated that the claimed subject matter can be implemented with various commercially available operating systems or combinations of operating systems.

A user can enter commands and information into the computer 502 through one or more wired/wireless input devices, e.g., a keyboard 538 and a pointing device, such as a mouse 540. Other input devices (not shown) may include a microphone, an IR remote control, a joystick, a game pad, a stylus pen, touch screen, or the like. These and other input devices are often connected to the processing unit 504 through an input device interface 542 that is coupled to the system bus 508, but can be connected by other interfaces, such as a parallel port, an IEEE 1094 serial port, a game port, a USB port, an IR interface, etc.

A monitor 544 or other type of display device is also connected to the system bus 508 via an interface, such as a video adapter 546. In addition to the monitor 544, a computer typically includes other peripheral output devices (not shown), such as speakers, printers, etc.

The computer 502 may operate in a networked environment using logical connections via wired and/or wireless communications to one or more remote computers, such as a remote computer(s) 548. The remote computer(s) 548 can be a workstation, a server computer, a router, a personal computer, portable computer, microprocessor-based entertainment appliance, a peer device or other common network node, and typically includes many or all of the elements described relative to the computer 502, although, for purposes of brevity, only a memory/storage device 550 is illustrated. The logical connections depicted include wired/wireless connectivity to a local area network (LAN) 552 and/or larger networks, e.g., a wide area network (WAN) 554. Such LAN and WAN networking environments are commonplace in offices and companies, and facilitate enterprise-wide computer networks, such as intranets, all of which may connect to a global communications network, e.g., the Internet.

When used in a LAN networking environment, the computer 502 is connected to the local network 552 through a wired and/or wireless communication network interface or adapter 556. The adaptor 556 may facilitate wired or wireless communication to the LAN 552, which may also include a wireless access point disposed thereon for communicating with the wireless adaptor 556.

When used in a WAN networking environment, the computer 502 can include a modem 558, or is connected to a communications server on the WAN 554, or has other means for establishing communications over the WAN 554, such as by way of the Internet. The modem 558, which can be internal or external and a wired or wireless device, is connected to the system bus 508 via the serial port interface 542. In a networked environment, program modules depicted relative to the computer 502, or portions thereof, can be stored in the remote memory/storage device 550. It will be appreciated that the network connections shown are illustrative and other means of establishing a communications link between the computers can be used.

The computer 502 is operable to communicate with any wireless devices or entities operatively disposed in wireless communication, e.g., a printer, scanner, desktop and/or portable computer, portable data assistant, communications satellite, any piece of equipment or location associated with a wirelessly detectable tag (e.g., a kiosk, news stand, restroom), and telephone. This includes at least Wi-Fi and Bluetooth™ wireless technologies. Thus, the communication can be a predefined structure as with a conventional network or simply an ad hoc communication between at least two devices.

Wi-Fi, or Wireless Fidelity, allows connection to the Internet from a couch at home, a bed in a hotel room, or a conference room at work, without wires. Wi-Fi is a wireless technology similar to that used in a cell phone that enables such devices, e.g., computers, to send and receive data indoors and out; anywhere within the range of a base station. Wi-Fi networks use radio technologies called IEEE 802.11x (a, b, g, etc.) to provide secure, reliable, fast wireless connectivity. A Wi-Fi network can be used to connect computers to each other, to the Internet, and to wired networks (which use IEEE 802.3 or Ethernet).

Wi-Fi networks can operate in the unlicensed 2.4 and 5 GHz radio bands. IEEE 802.11 applies to generally to wireless LANs and provides 1 or 2 Mbps transmission in the 2.4 GHz band using either frequency hopping spread spectrum (FHSS) or direct sequence spread spectrum (DSSS). IEEE 802.11a is an extension to IEEE 802.11 that applies to wireless LANs and provides up to 54 Mbps in the 5 GHz band. IEEE 802.11a uses an orthogonal frequency division multiplexing (OFDM) encoding scheme rather than FHSS or DSSS. IEEE 802.11b (also referred to as 802.11 High Rate DSSS or Wi-Fi) is an extension to 802.11 that applies to wireless LANs and provides 11 Mbps transmission (with a fallback to 5.5, 2 and 1 Mbps) in the 2.4 GHz band. IEEE 802.11 g applies to wireless LANs and provides 20+ Mbps in the 2.4 GHz band. Products can contain more than one band (e.g., dual band), so the networks can provide real-world performance similar to the basic 10BaseT wired Ethernet networks used in many offices.

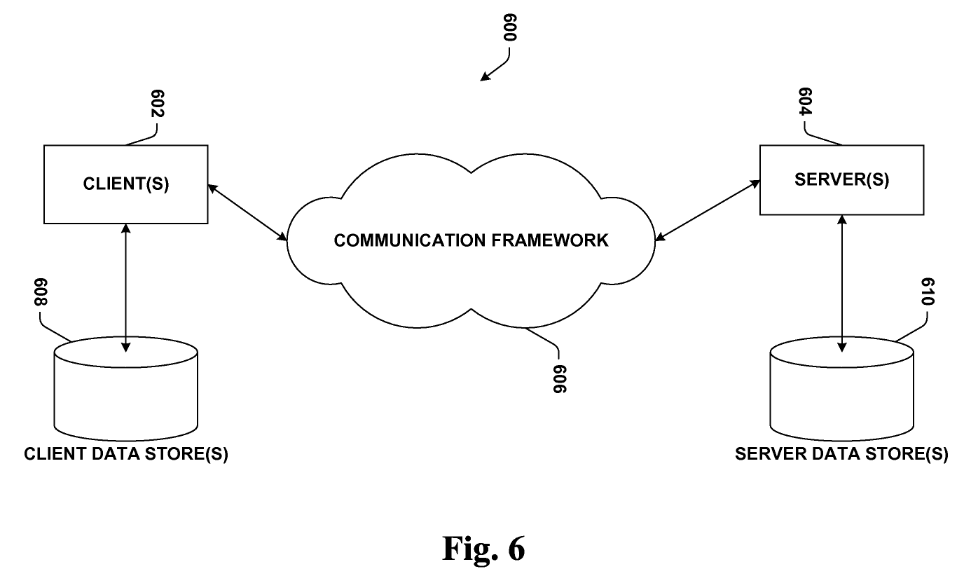

Referring now to FIG. 6, there is illustrated a schematic block diagram of an illustrative computing environment 600 for processing the disclosed architecture in accordance with another aspect. The system 600 includes one or more client(s) 602. The client(s) 602 can be hardware and/or software (e.g., threads, processes, computing devices). The client(s) 602 can house cookie(s) and/or associated contextual information by employing the claimed subject matter, for example.

The system 600 also includes one or more server(s) 604. The server(s) 604 can also be hardware and/or software (e.g., threads, processes, computing devices). The servers 604 can house threads to perform transformations by employing the claimed subject matter, for example. One possible communication between a client 602 and a server 604 can be in the form of a data packet adapted to be transmitted between two or more computer processes. The data packet may include a cookie and/or associated contextual information, for example. The system 600 includes a communication framework 606 (e.g., a global communication network such as the Internet) that can be employed to facilitate communications between the client(s) 602 and the server(s) 604.

Communications can be facilitated via a wired (including optical fiber) and/or wireless technology. The client(s) 602 are operatively connected to one or more client data store(s) 608 that can be employed to store information local to the client(s) 602 (e.g., cookie(s) and/or associated contextual information). Similarly, the server(s) 604 are operatively connected to one or more server data store(s) 610 that can be employed to store information local to the servers 604.

What has been described above includes examples of the subject innovation. It is, of course, not possible to describe every conceivable combination of components or methodologies for purposes of describing the claimed subject matter, but one of ordinary skill in the art may recognize that many further combinations and permutations of the subject innovation are possible. Accordingly, the claimed subject matter is intended to embrace all such alterations, modifications, and variations that fall within the spirit and scope of the appended claims.

In particular and in regard to the various functions performed by the above described components, devices, circuits, systems and the like, the terms (including a reference to a “means”) used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the innovation includes a system as well as a computer-readable medium having computer-executable instructions for performing the acts and/or events of the various methods of the claimed subject matter.

There are multiple ways of implementing the present innovation, e.g., an appropriate API, tool kit, driver code, operating system, control, standalone or downloadable software object, etc. which enables applications and services to use the techniques of the invention. The claimed subject matter contemplates the use from the standpoint of an API (or other software object), as well as from a software or hardware object that operates according to the techniques in accordance with the invention. Thus, various implementations of the innovation described herein may have aspects that are wholly in hardware, partly in hardware and partly in software, as well as in software.

The aforementioned systems have been described with respect to interaction between several components. It can be appreciated that such systems and components can include those components or specified sub-components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components may be combined into a single component providing aggregate functionality or divided into several separate sub-components, and any one or more middle layers, such as a management layer, may be provided to communicatively couple to such sub-components in order to provide integrated functionality. Any components described herein may also interact with one or more other components not specifically described herein but generally known by those of skill in the art.

In addition, while a particular feature of the subject innovation may have been disclosed with respect to only one of several implementations, such feature may be combined with one or more other features of the other implementations as may be desired and advantageous for any given or particular application. Furthermore, to the extent that the terms “includes,” “including,” “has,” “contains,” variants thereof, and other similar words are used in either the detailed description or the claims, these terms are intended to be inclusive in a manner similar to the term “comprising” as an open transition word without precluding any additional or other elements.

What is claimed is:

1. A system that facilitates destruction of a target material in a target containing material without detrimentally effecting surrounding healthy structures, comprising:
an ultrasound generator operable to produce ultrasound at about a resonant frequency of the target material, the resonant frequency of the target material different than resonant frequencies of the surrounding healthy structures;
a settings component for selecting the resonant frequency of the target material;
a datastore comprising information associated with the resonant frequency of the target material; and
a processor-controller operable to signal the ultrasound generator to produce ultrasound at about the resonant frequency of the target material.

2. The system of claim 1, the settings component selects a narrow band of frequencies comprising the resonant frequency of the target material, the narrow band of frequencies not comprising the surrounding healthy structures resonant frequencies.

3. The system of claim 1, the settings component selects the resonant frequency of the target material as a function of at least one of depth of the target material in the target containing material, shape of the target material, size of the target material, identity of materials through which the ultrasound passes between the ultrasound generator and the target material, number of material boundries or tissue interfaces in the target containing material through which the ultrasound passes between the ultrasound generator and the target material.

4. The system of claim 1, the datastore comprising a resonant frequency datastore, a patient attribute datastore, and an ultrasound settings datastore.

5. The system of claim 1, the target material comprises DNA, RNA, proteins, carbohydrates, lipids, lipopolysaccharides, glycolipids, glycoproteins, proteoglycans, chloroplasts, mitochondria, endoplasmic reticulum, cells, organs, viruses, bacteria, protozoans, parasites, fungi, worms, mollusks, arthropods, tissue masses, cancer cells/tissues, tumors, cysts, fibrosis, mucous, diseased tissue, or combinations thereof.

6. The system of claim 1, the target material comprising a virus.

7. The system of claim 1, with the proviso that the system does not comprise using radiowaves or electromagnetic radiation.

8. The system of claim 1, further comprising an intelligent agent component coupled to the settings component.

9. A method of destroying a target material in a target containing material without detrimentally effecting surrounding healthy structures, comprising:
selecting or determining a resonant frequency of the target material;
modifying the resonant frequency of the target material based upon at least one of depth of the target material in the target containing material, identity of materials through which the ultrasound passes between an ultrasound generator and the target material, number of material boundries or tissue interfaces in the target containing material through which the ultrasound passes between the ultrasound generator and the target material, and resonant frequency of surrounding healthy structures; and
directing ultrasound to the target containing material comprising the target material at about the modified resonant frequency of the target material to destroy the target material without substantially harming surrounding healthy structures.

10. The method of claim 9, directing ultrasound to the target containing material to destroy the target material comprises:
directing ultrasound to the target containing material to change the target containing material so that obstructed antigenic components of the target containing material become more easily accessible to an immune response.

11. The method of claim 9, the target containing material comprises a sample from a living body.

12. The method of claim 9, directing ultrasound to the target containing material comprises using a power intensity from about 0.01 to about 1×10¹¹ W/m².

13. The method of claim 9, ultrasound being directed to the target containing material for a duration of time sufficient to destroy at least about 25% by weight of the target material present.

14. The method of claim 9, the target containing material comprises a blood sample from a living body and the target material comprising HIV.

15. The method of claim 9, the target containing material comprises a living body and the target material comprising cancerous cells.

16. The method of claim 9, directing ultrasound to the target containing material through a coupling medium.

17. A method of treating a disease, comprising:
selecting or determining a resonant frequency of a target material associated with the disease;
modifying the resonant frequency of the target material based upon at least one of depth of the target material in a target containing material, identity of materials through which the ultrasound passes between an ultrasound generator and the target material, number of material boundries or tissue interfaces in the target containing material through which the ultrasound passes between the ultrasound generator and the target material, and resonant frequency of surrounding healthy structures; and
directing ultrasound to the target containing material comprising the target material at about the modified resonant frequency of the target material to destroy the target material without substantially harming surrounding healthy structures.

18. The method of claim 14, the disease comprising cancer or a retrovirus disease.

19. The method of claim 14, ultrasound being directed to the target containing material intermittently or continuously.

20. The method of claim 14, modifying the resonant frequency of the target material comprises considering at least one of percent fat in a target containing material, medical history of the target containing material, sensitivity to ultrasound of the target containing material, food/fluids recently consumed by the target containing material, the presence of non-target materials that have resonant frequencies relatively close to the resonant frequency of the target material, current temperature, current pressure, and ultrasound machine generator unique attributes.
